(19) United States
(12) Patent Application Publication
(10) Pub. No.: US 2007/0045237 A1
(43) Pub. Date: Mar. 1, 2007

(54) Method of arc-joining

(75) Inventors: Christoph Matz, Unterschleissheim (DE); Ernst Miklos, Kirchheim (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/504,888

(22) Filed: Aug. 15, 2006

(30) Foreign Application Priority Data
Aug. 26, 2005 (DE) 10 2005 040 552.5

(51) Int. Cl. B23K 9/173

(52) U.S. Cl. 219/74

(57) ABSTRACT

A method of arc-joining a workpiece with a consumable electrode and with the use of an inert gas shield and a short arc is disclosed. Material is dispensed by the melting electrode to the workpiece while an electronically controlled electrical short circuit is formed. An inert gas is used that consists of 50 to 5000 vpm (0.005 to 0.5 vol. %) of oxygen, carbon dioxide, nitrogen monoxide, nitrogen, dinitrogen monoxide, or of a mixture of these gases, in argon or in an argon/helium mixture.

This application claims the priority of German Patent Document No. 10 2005 040 552.5, filed Aug. 26, 2005, the disclosure of which is expressly incorporated by reference herein.

### BACKGROUND AND SUMMARY OF THE INVENTION

The invention relates to a method of arc-joining a workpiece with a consumable electrode and with the use of an inert gas shield and a short arc, whereby material is dispensed by the melting electrode to the workpiece while an electronically controlled electrical short circuit is formed.

Arc-joining with the use of an inert gas requires a frequently used joining technique. In so doing, a light arc burns between an electrode arranged in a burner and the workpiece that is to be processed. As a result, a welding joint is created by melt-depositing the basic work material on the processed site in the light arc and by the subsequent solidification of the work material. If a consumable electrode is used, the material of the electrode enters the welding joint as a filler material. When a brazing metal joint is formed, the bonded joint is created by the melted and re-solidified soldering material which is added as the filler material. In so doing, the basic work material is not melt-deposited, rather an interlocking of the soldering material and the basic work material takes place. In brazing with the use of an arc, this is usually done with a consumable electrode. Various techniques exist for the transfer of the electrode material, whereby these also result in differently burning arcs. For example, there are spray arcs, arcs with globular droplet transfer, rotating arcs with droplet transfer and short arcs. Referring to a short arc, an electrical short circuit is created between the electrode and the workpiece—the latter being poled as the second electrode—during the electrode material transfer, i.e., when the liquid or dough-like material begins to detach from the electrode and a bridge is formed between the electrode and the workpiece. As a result of the short circuit, the droplet that begins to detach from the electrode necks in, whereupon the droplet detaches from the electrode. The arc again re-ignites in the electrical field which now exists again after the short circuit has been discontinued. A new cycle begins. In most welding tools, the welding current is controlled downward or switched off at the moment at which the short circuit is created. Consequently, the welding current must be applied again in order to be able to re-ignite the arc. The arc is switched off in this manner in order to inhibit the spray formation that accompanies the formation of the short circuit. In older devices, the arc is switched off by means of an electric throttle; in newer devices, this is achieved by means of an electronic control.

During the joining process, heat is locally introduced into the workpiece. On the one-hand, this is necessary to liquefy the workpiece and the filler material, to allow a molten weld pool to form, and to thus obtain a bonded joint following solidification. On the other hand, however, the introduction of heat is accompanied by problems. For example, due to the temperature difference, stresses occur in the workpiece which lead to a distortion of the component part. When thin workpieces are welded, in particular, thin metal sheets having a thickness of a few millimeters, the melt is easily blown out of the weld pool, so that holes are formed. Also, problems occur when coated workpieces are joined, i.e., coatings—which evaporate at a relatively lower temperature than the basic work material—result in the formation of smoke due to the introduction of heat, thereby causing enclosures and pores in the welding seam. The last-mentioned problems manifest themselves, in particular, when zinc-plated metal sheets are joined.

Basically, considering all types of arcs, the short arc uses the least introduction of heat. In order to reduce problems based on the introduction of heat, this positive feature relating to the introduction of heat, which is offered by the method of welding and brazing with short arcs, was most recently developed further with the objective of minimizing the introduction of heat. The prerequisite for this was the possibility of an electronic control. As a result of the electronic control, mainly the short circuit current is minimized, so that the heat introduction into the workpiece is reduced. Further, the electronic control allows the attenuation of the abruptness with which the short circuit bridge moves and with which the material transfer takes place, so that welding spray is noticeably decreased. In so doing, the electronic control mostly affects the current and voltage values. At times, the wire transport is included in the control. Methods and apparatus for welding with electronically controlled short arcs have been mentioned, for example, in US 2005/0056629, EP 1462207, EP 1379354, WO 2005/042199 and WO 2005/051586. Considering these references, only EP 1462207 recommends argon or a mixture of argon containing a small percentage of oxygen as the inert gas.

Referring to this short arc joining process with electronic control, problems arise when the arc is re-ignited. The speed with which the arc burns again between the electrode and the workpiece after the short circuit phase is decisive regarding the quality of the welding seam, and the permissible welding speed is also mostly defined by the reignitability. Problems due to the inadequate reignitability lead to irregularly sized beads and to pores and to flaws in the welding seam. Also, the soldering connection will be irregular and porous. In particular, these quality defects mostly manifest themselves at high process speeds.

Therefore, the object of the invention is to provide a method which increases the reignitability of the electronically controlled short arc so that, even at high process speeds, high-quality welding seams and solder bonds are formed.

### DETAILED DESCRIPTION OF THE EXEMPLARY EMBODIMENTS

In accordance with the invention, this problem is solved in that the inert gas that is used consists of 50 to 5000 vpm (0.005 to 0.5 vol. %) of oxygen, carbon dioxide, nitrogen monoxide, nitrogen, dinitrogen monoxide or of a mixture of these gases in argon or in an argon/helium mixture. Surprisingly, it has been found that the inventive method results in an improved reignitability of the arc. As a result of this, the entire joining process becomes distinctly more stable and thus easier to control. As a result of this, the welding seam or soldering seam is filled uniformly with the filler material, a consistent bead is created and the pore frequency is clearly reduced. These advantages are attained also at high process speeds which, until now, could be controlled only with great difficulty.

The improved reignitability is attributable to the properties of the inert gas mixture that is being used. The oxygen/carbon dioxide/nitrogen monoxide/nitrogen/dinitrogen monoxide used as the doping gas in the inert gas mixture deposit on the surface of the workpiece. At these sites, a super-intensification of the electric field occurs, the intensification being due to the application of the welding voltage between the electrode and the workpiece. Now, the plasma formation begins at these sites. First only the argon ionizes. As a result of the electrons that are liberated during the ionization, the arc begins to burn, as a result of which the energy input is significantly increased. Now the workpiece material evaporates, and the evaporated material is ionized. Inasmuch as the material-compared with argon-ionizes much more readily, the electron emission increases significantly and the arc now burns in a stable manner. By doping at 50 to 5000 vpm, individual islands of deposited doping gas are formed in a number that is adequate to permit the plasma formation to set in a rapid and stable manner. On the other hand, considering this kind of doping, the concentration of the doping gases is low enough that undesirable metallurgical effects do not occur. This applies not only to relatively insensitive work materials such as, for example, all types of steel, but also to sensitive work materials such as, for example, aluminum, aluminum alloys or titanium. Argon is a necessary component of the inert gas mixture because, due to the ionization of the argon, the electron emission sets in and the arc begins to burn. Helium, which exhibits high thermal conductivity, aids the starting metal vapor plasma formation of the material and is thus of advantage.

Furthermore, it has been found, surprisingly, that with the use of the inventive inert gas mixture on the welding device, a relatively low welding voltage can be chosen and that the occurring welding current also decreases. Consequently, the introduced power is reduced. As a result, the heat that is introduced into the workpiece and that is already very minimal in the electronically controlled short arc is reduced even further. This improves the processing of thin metal sheets because the susceptibility to perforations can be reduced significantly due to the inventive minimal heat introduction in accordance with the invention. Also, processing of coated metal sheets, in particular, zinc-coated metal sheets, becomes easier, because, due to the minimal introduction of heat, the evaporation of the coating material is minimized. Furthermore, as regards distortion, the sensitivity of the processed workpieces is reduced because of the reduced introduction of heat. This reduction of the introduction of heat is a result of the improved reignitability of the electronically controlled short arc in accordance with the inventive method.

Advantageously, the inert gas contains 10 to 40 vol. % of helium. The helium component should not exceed the upper limit, so that sufficient argon is contained in the inert gas, thus allowing plasma formation to start in a quick and stable manner. If less helium than stated is contained in the inert gas, an effect on the welding process due to the high thermal conductivity of the helium is not noticed. Preferably, the inert gas contains 25 to 35 vol. % of helium. Considering these percentages of helium, the properties of the inert gas resulting from the helium will be particularly pronounced.

Preferably, the inert gas contains 200 to 600 vpm (0.02 to 0.06 vol. %) of oxygen, carbon dioxide, nitrogen monoxide, nitrogen, dinitrogen monoxide or a mixture of these gases. Considering this doping, the reignitability is aided in a particularly advantageous manner.

It has been found that the inventive method displays the aforementioned advantages in a particularly excellent manner when the inert gas consists of 300 vpm (0.03 vol. %) of oxygen, 30 vol. % of helium, and of argon in the remaining amount by volume. Furthermore, it has been found—if doping occurs with carbon dioxide—that the advantages of the invention will be achieved also with an inert gas mixture consisting of 300 vpm (0.03 vol. %) of carbon dioxide, 25 to 30 vol. % of helium, and of argon in the remaining amount by volume. When doping occurs with nitrogen monoxide, the use of an inert gas that consists of 300 vpm (0.03 vol. %) of nitrogen monoxide, 30 vol. % of helium, and of argon in the remaining amount, is recommended.

The inventive method displays its advantages when workpieces having a thickness of less than 5 mm, preferably less than 3 mm, are joined. In so doing, even thin metal sheets having thicknesses of a few millimeters can be joined without holes.

Referring to an advantageous embodiment of the invention, workpieces of aluminum or of aluminum alloys are welded together. Due to the low concentration of doping gases, no metallurgical reaction sets in, and the advantages of the invention can also be utilized in the case of these sensitive work materials.

Referring to another advantageous embodiment of the invention, workpieces of steel alloys are welded together. Also, in the case of these work materials, the advantages of the inventive method will manifest themselves.

Referring to another advantageous embodiment of the invention, a workpiece of aluminum or of an aluminum alloy is joined to a workpiece of steel or of coated steel, with the use of an aluminum-based solder. Due to the extremely low heat introduction of the inventive method, high-quality joint connections can also be produced with these diverse materials. In fact, this is possible in the case of coated and, specifically, in the case of zinc-plated steel. To produce the joint, the workpiece of aluminum or of aluminum alloy melts, whereas the workpiece of steel is only heated. The bonded joint thus represents a mixed form of a welding and soldering bond.

Referring to another advantageous embodiment of the invention, workpieces of coated or of uncoated steel alloys are soldered together with a soldering material on a copper/aluminum basis or on a copper/silicon basis. Even when brazing with an arc, the reignitability of the electronically controlled arc is improved with the inventive method. The above statements also apply to soldering because the ignition mechanism and the plasma formation are approximately identical in both joining techniques.

Referring to another advantageous embodiment of the invention, a workpiece of aluminum or of an aluminum alloy is soldered to a workpiece of steel or of coated steel with the use of a zinc-based solder. Also in this case the inventive advantages manifest themselves.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of arc-joining workpieces with a consumable electrode, an inert gas shield, and a short arc, wherein material is dispensed by the consumable electrode when melting to the workpieces while an electronically controlled electrical short circuit is formed, wherein the inert gas consists of 50 to 5000 vpm (0.005 to 0.5 vol. %) of oxygen, carbon dioxide, nitrogen monoxide, nitrogen, dinitrogen monoxide, or of a mixture of these gases, in argon or in an argon/helium mixture.

2. The method according to claim 1, wherein the inert gas contains 10 to 40 vol. % of helium.

3. The method according to claim 1, wherein the inert gas contains 200 to 600 vpm (0.02 to 0.06 vol. %) of oxygen, carbon dioxide, nitrogen monoxide, nitrogen, dinitrogen monoxide or of a mixture of these gases.

4. The method according to claim 1, wherein the inert gas consists of 300 vpm (0.03 vol. %) of oxygen, 30 vol. % of helium, and of argon in a remaining amount by volume.

5. The method according to claim 1, wherein the workpieces have a thickness of less than 5 mm.

6. The method according to claim 1, wherein the workpieces are comprised of aluminum or of aluminum alloys.

7. The method according to claim 1, wherein the workpieces are comprised of steel alloys.

8. The method according to claim 1, wherein the workpieces include a workpiece of aluminum or of an aluminum alloy that is joined to a workpiece of steel or of coated steel, with use of an aluminum-based solder.

9. The method according to claim 1, wherein the workpieces are comprised of coated or of uncoated steel alloys and are soldered together with a soldering material on a copper/aluminum basis or on a copper/silicon basis.

10. The method according to claim 1, wherein the workpieces include a workpiece of aluminum or of an aluminum alloy that is soldered to a workpiece of steel or of coated steel, with use of an aluminum-based solder.

11. A method of arc-joining a workpiece, comprising the steps of:
igniting an arc between a consumable electrode and the workpiece;
forming an electrical short circuit between the consumable electrode and the workpiece;
turning off the arc while the electrical short circuit is formed;
terminating the electrical short circuit; and
reigniting the arc after the electrical short circuit has been terminated, wherein an inert gas is used when reigniting the arc and wherein the inert gas consists of 0.005 to 0.5 volume percentage of one of a gas of oxygen, carbon dioxide, nitrogen monoxide, nitrogen, or dinitrogen monoxide, or of a mixture of the gases, in argon or in an argon/helium mixture.

12. The method according to claim 11, wherein during the reigniting step the one of the gases of oxygen, carbon dioxide, nitrogen monoxide, nitrogen, or dinitrogen monoxide is deposited at a site on a surface of the workpiece.

13. The method according to claim 12, wherein during the reigniting step, plasma formation begins to occur at the site of the deposited gas.

14. The method according to claim 13, wherein during the reigniting step, the argon ionizes first and the arc begins to reignite as a result of the ionization of the argon.

15. The method according to claim 14, wherein during the reigniting step, after the argon ionizes, a workpiece material evaporates, the evaporated material ionizes, and the arc burns in a stable manner as a result of the ionization of the material.
